(19) United States
(12) Patent Application Publication
(10) Pub. No.: US 2015/0019498 A1
(43) Pub. Date: Jan. 15, 2015

(54) Systems and Methods for Generating a Document with Internally Consistent Data

(71) Applicants: Aleksei Rubinov, Moscow (RU); Kirill Mikov, Perm City (RU)

(72) Inventors: Aleksei Rubinov, Moscow (RU); Kirill Mikov, Perm City (RU)

(21) Appl. No.: 14/325,851

(22) Filed: Jul. 8, 2014

Related U.S. Application Data
(60) Provisional application No. 61/844,475, filed on Jul. 10, 2013.

(51) Int. Cl. G06F 17/30; G06Q 40/00; G06F 3/0484

(52) U.S. Cl. CPC G06F 17/30115; G06F 3/04842; G06Q 40/00
USPC 707/687

(57) ABSTRACT

Systems and methods for generating a document include creating, by a computing device, a link between a first data element in a document and a second data element in a document. A relationship function between the first data element and the second data element is created to define a data dependency between the first and second data elements. One or more verification functions is associated with the link to verify that the data dependency has been me. Each data dependency in the document is verified to determine the data dependency is met. One or more data dependencies are corrected by computing corrected data via the relationship function. Either the first or second data element is replaced with the corrected data. A final document that includes the corrected data is generated.

### RELATED APPLICATIONS

This application claims priority to and benefit of U.S. Provisional Application No. 61/844,475 (filed Jul. 10, 2013), which is incorporated here by reference in its entirety.

### FIELD

This disclosure relates to document generation and, more particularly, to generating a financial document with internally consistent financial information.

### BACKGROUND

Financial documents are used by companies for reporting financial information. Some documents are used internally by the company and its stakeholders. Others are required by law for public disclosure, such as SEC disclosure.

Such financial documents can be complex—they may contain many tables, numbers, and other types of data. The same data may need appear in many places in the document. Also, some data elements rely on and are computed based on the value of another data element. In a complex document, it can be cumbersome for a user to manually check and verify that all the data elements in the document have the correct values after they are updated.

### SUMMARY

In an embodiment, a method for generating a document includes creating, by a computing device, a link between a first data element in a document and a second data element in a document. A relationship function between the first data element and the second data element is created to define a data dependency between the first and second data elements. One or more verification functions is associated with the link to verify that the data dependency has been met. Each data dependency in the document is verified to determine the data dependency is met. One or more data dependencies are corrected by computing corrected data via the relationship function. Either the first or second data element is replaced with the corrected data. A final document that includes the corrected data is generated.

One or more of the following features may be included. A user interface may indicate any data dependencies that have not been met. The user interface may allow a user to correct one or more data dependencies that have not been met. The relationship function may include a hard data dependency, a soft data dependency, or both. Correcting the one or more data dependencies may include obtaining, from a user, verification of the correct data. The relationship function may be a formula that defines a mathematical relationship between the first data element and the second data element. The relationship function may be a flag indicating the existence of a relationship between the first data element and the second data element.

A plurality of relationship functions between the first data element and the second data element may be created. If the relationship function comprises a mathematical formula, at least one of the verification functions may be a function that calculates the result of the formula. If the relationship function is a flag indicating the existence of a relationship, at least one of the verification functions may be a function that queries a user as to whether the dependency has been met. Generating the final document may include populating one or more tables in the document with the corrected data. The data may comprise text elements, numerical elements, or both. A user interface that allows a user to define the relationship function between the first data element and the second data element may be provided. The final document may be a financial report containing data dependencies between elements in the report.

In another embodiment, a system for generating a document includes a computing device configured to create a link between a first data element in a document and a second data element in a document. A relationship function between the first data element and the second data element is created to define a data dependency between the first and second data elements. One or more verification functions is associated with the link to verify that the data dependency has been met. Each data dependency in the document is verified to determine the data dependency is met. One or more data dependencies are corrected by computing corrected data via the relationship function. Either the first or second data element is replaced with the corrected data. A final document that includes the corrected data is generated.

One or more of the following features may be included. The relationship function may comprise a hard data dependency, a soft data dependency, or both. Correcting the one or more data dependencies may include obtaining, from a user, verification of the correct data. The relationship function may be a formula that defines a mathematical relationship between the first data element and the second data element. The relationship function may be a flag indicating the existence of a relationship between the first data element and the second data element.

### BRIEF DESCRIPTION OF THE DRAWINGS

The foregoing features may be more fully understood from the following description of the drawings. The drawings aid in explaining and understanding the disclosed technology. Since it is often impractical or impossible to illustrate and describe every possible embodiment, the provided figures depict one or more exemplary embodiments. Accordingly, the figures are not intended to limit the scope of the invention. Like numbers in the figures denote like elements.

FIG. 1 is a block diagram of a system for generating a document.

FIG. 2A is table with financial data.

FIG. 2B is a table with financial data.

FIG. 3 is flow chart of a process for generating a document.

FIG. 4 is a screenshot of a graphical user interface.

FIG. 5 is a screenshot of a graphical user interface.

FIG. 6 is a screenshot of a graphical user interface.

FIG. 7 is a flowchart of a process for processing data elements.

FIG. 8A and FIG. 8B is a flowchart of a process for processing data elements.

FIG. 9 is a screenshot of an example of a financial document.

FIG. 10 is a block diagram of a computing device.

### DETAILED DESCRIPTION

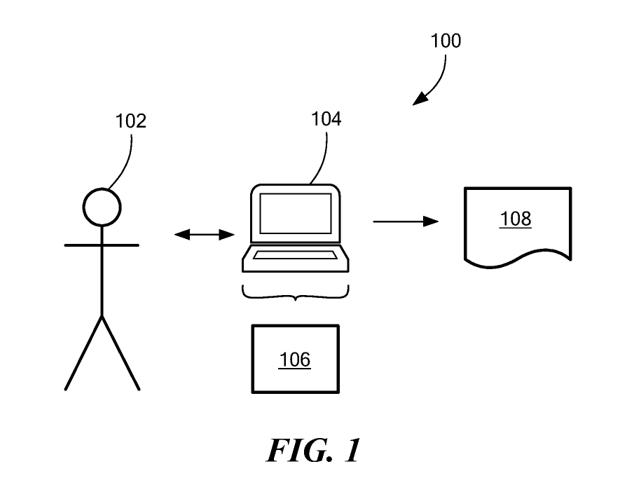

Referring to FIG. 1, a system 100 for generating a document is shown. The system 100 includes a computing device 104, which may comprise a laptop, a desktop, a mobile device, a server, a tablet, or any other type of computing device. Computing device 104 may include a processor (not shown in FIG. 1) to execute software including, but not limited to, an operating system, applications, and/or document generation software 106. Computing device 104 may also include various user interface elements so that user 102 can interact with computing device 104 and/or document generation software 106. These include a display screen or monitor, a keyboard, a pointing device or touch screen, etc.

When executed by computing device 104, document generation software 106 may be configured to produce a financial document 108. The financial document 108 may be a financial report that contains data and information relating to financial disclosure, financial auditing, financial reporting, etc. In an embodiment, the financial document may be used for communicating financial data by an individual, or by a company to the public, to internal employees, or to other stakeholders. One skilled in the art will recognize that, although document 108 is described as a financial document, document 108 may be any type of document having complex data and information.

In an embodiment, document generation software 106 will generate financial document 108 with input from user 102. As an example, document generation software 106 may prompt user 102 for input of data that will be contained in document 108, may display data or portions of document 108 to user 102 on a display, may provide input fields to allow user 102 to enter data that will become part of document 108, etc.

Document 108 may be a complex document containing interrelated data. As will be discussed below, document generation software 106 may include features and functions that establish consistency between data elements within document 108. Software 106 may also act as a word processor, text editor, or other type of program that allows user 102 to make changes to text, images, or other elements in document 108 that may not be interrelated to other data within document 108.

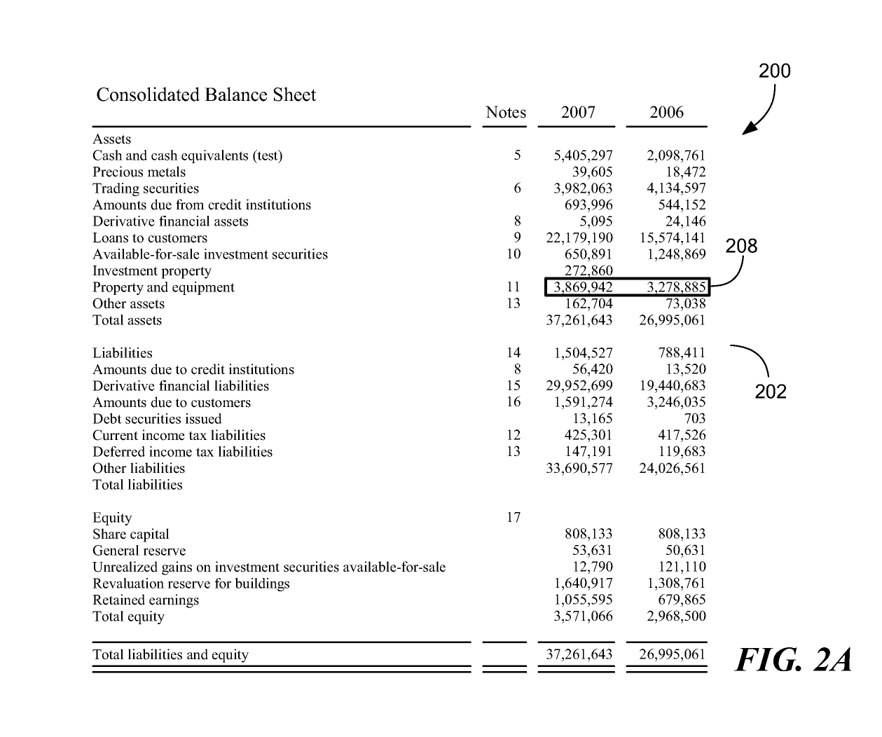

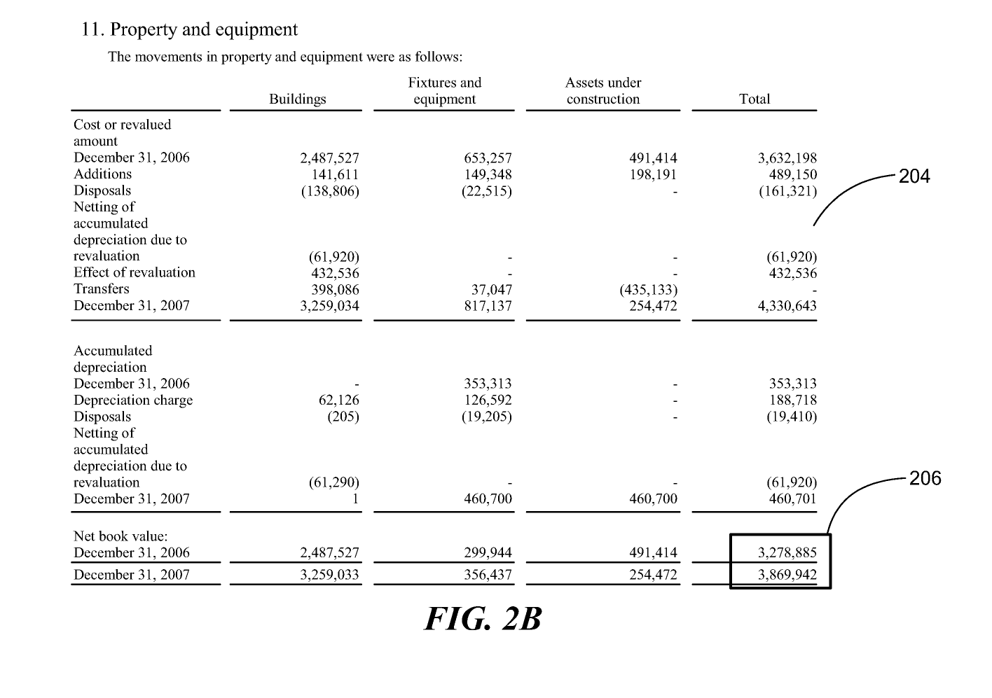

FIG. 2A and FIG. 2B are examples of screenshots of a financial document for a company, which may be the same as or similar to financial document 108. Screenshot 200 in FIG. 2A shows a consolidated balance sheet table having numerical values organized in columns. The table has a column that lists assets, a notes column, and two columns labeled 2007 and 2006 that contain numerical dollar figures associated with the assets. In a complex financial document, these dollar figures may need to be duplicated in various locations within the document.

As an example, the dollar figures for “Property and Equipment” are shown as 3,278,885 in the 2006 column and 3,869,942 in the 2007 column. Referring now to FIG. 2B, a table 204 titled “Property and Equipment” shows a more detailed view of the company's property and equipment assets. Table 204 contains depreciation numbers for buildings, fixtures and equipment, and assets under construction. Highlighted in box 206 are the sum total dollar figures for property and equipment for the company for the years 2006 and 2007. In this example, these dollar figures must match the values listed in box 208 in FIG. 2A so that the document 108 will contain accurate, consistent data. Values such as these may appear numerous times throughout the document 108. If a user were to manually update one or more of these figures, it may introduce errors if the user fails to update every instance of the figures throughout the document.

Additionally or alternatively, these dollar figures such as those in boxes 206 and 208 may be used as inputs to formulas in the document that compute other numbers. The o output of these formulas may rely on the input values so that, if the input value changes, the output value will also change. For example, the document may contain a bottom line number that is the sum of the dollar figures of all the elements listed as assets. If one of the asset values is added, removed, or edited, then the sum value will also need to change. These outputs of these formulas may also need to appear in one or more places within the document, and may also be used as inputs to other formulas. Although a sum is used as an example, one skilled in the art will recognize that any numerical value in the document can be used as an input to any type of mathematical formula to produce other numbers or value that may appear in the document. Thus, if a user were to manually update one or more of these figures, it may introduce errors in the document if the user fails to update every other value that relies on the edited value.

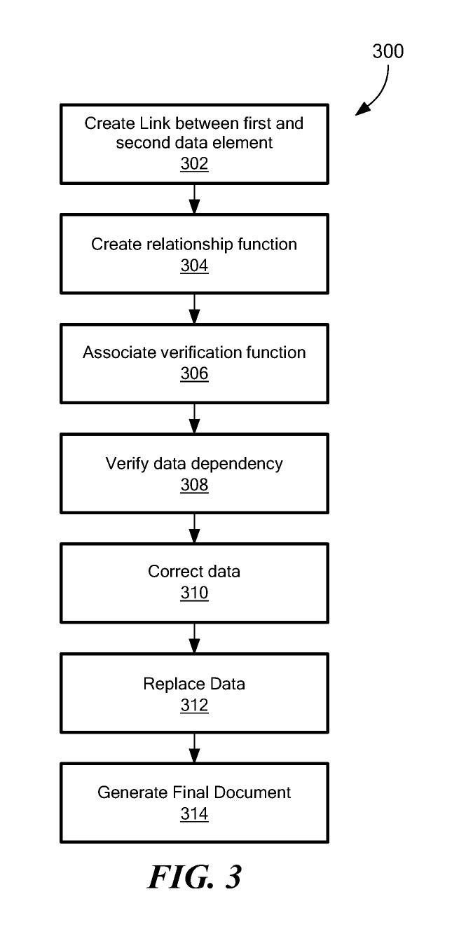

Referring to FIG. 3, a process 300 for generating a document 108 is shown. In block 302, application 106 may create a link between a first and second data element that are to be included in a financial document. The link is an association between the first and second data elements that indicates that the first and second data elements are related. The link may be a so-called hard link or a so-called soft link. A hard link may indicate that the first and second data elements are to be related by a mathematical formula. A soft link may indicate that the first and second data elements are related, but not necessarily by a mathematical formula. For example, text in the document may be related to a numerical value in the document.

For example, the text “Sales growth in the current year is in line with the overall market trend” may appear in the document and may be linked via a soft link to a numerical value in a table that represents a sales figure. Should the sales variation number become negative during editing of the document, the related text statement may no longer be applicable (because, for example, if the number is negative, the text statement may no longer be true). A soft link can be used to define a relationship between the text and the number so that a user can subsequently verify that the link is applicable.

As another example, if the mathematical formula is complex it may be beneficial to use a soft link and allow the user to verify numbers in the document. For example, the relationship between weight, max speed, and engine power of a vehicle may be a complex formula. It may be more practical to link these values via a soft link to allow the user to verify their accuracy, rather than enter the formula into the document and system.

In block 304, a relationship function is created between the first and second data element. The relationship function defines a relationship between the data elements. As an example, if two data elements in the document should be equal, then the relationship function may be an equality function or rule that states the data elements must be equal. Of course other mathematical relationships between data elements may be used as a relationship function between the data elements. Data elements can also be linked to multiple other data elements in a one-to-many relationship. In an embodiment, a data element may have multiple relationships with multiple other data elements in the document in a one-to-many relationship. If a first data element is a sum of two or more other data elements, for example, then the relationship function may be a sum function or rule stating that the value of the first data element must be the sum of the values of the other data elements. Alternatively, data elements may have one-to-many relationships if the data (or a computed value that depends on the data) is to appear in the document in multiple locations. In this scenario, the first data element may have a link and relationship function with each other instance where the data (or a computed value that depends on the data) is to appear in the document.

The relationship function may be unidirectional or bidirectional. Say, for example, that the value of data element A should be twice the value of data element B (i.e. A=2*B). A unidirectional relationship may be set up so that when one of the data elements changes, the other should also change. For example, whenever A is changed, the value of B also should change. A bidirectional relationship function may set up rules for data consistency so that, if any linked data element changes, then any related data element should change. In this example, the bidirectional relationship function may include two formulas: A=2*B and B=A/2. If A changes, then B can be computed with the formula B=2/A; and if B changes, then A can be computed with the formula A=2*B. This example uses two elements and two formulas. However, a relationship function may contain a set of formulas defining the relationship between any two or more data elements.

Table 1 contains additional examples of relationship functions and verification functions.

TABLE 1

| | | Is applicable when | |
|---|---|---|---|
| | | Element A | Element A |
| Function | Example | is number | is text |

Defining functions

| | | | |
|---|---|---|---|
| Defining formula | A = B + 20 | Yes | Yes |
| Hard link | A is B (same element, but | Yes | Yes |
| | in different location) | | |

Verifying functions

| | | | |
|---|---|---|---|
| Verifying formula | A should be =, < or > B | Yes | Yes |
| (automatic | | | |
| verification) | | | |
| Consistency (soft) | A should be consistent with B | Yes | Yes |
| link (manual | | | |
| verification) | | | |

The relationship function need not be a mathematical function. If the one data element is text, for example, the relationship function may be a conversion function, a concatenation function, a substring function, etc. In general, any function that can define a relationship between data elements may be created and used as a relationship function between data elements. As another example, if the link between two data elements is a soft link that requires a user to verify consistency between the data elements, then the relationship function may be a function that identifies the link between the data elements as a soft link.

In box 306, a verification function is associated with a data element and/or with a relationship function. The verification function may be a function that verifies that the first data element and the second data element are consistent within the document. If the relationship between the first and second element is a hard link, then the verification function may use the relationship function between the first and second data elements to determine whether the first and second data are consistent. For example, if the first element and the second element should be equal in the document, then the relationship function is an equality function. In this case, the verification function may run the first (and/or second) data through the equality function to determine if they are equal. If they are equal, then the verification function will return a result indicating that the data dependency between the data elements has been met. If the values are not equal, then the verification function will return a result indicating that there is a discrepancy in the data.

If the link between the first and second element is a soft link, then the verification function may be a function that prompts a user for verification by, for example, providing the user with a prompt. The user can then manually check the data to determine if the data is consistent. If the data is not consistent, the verification function may allow the user to edit the data and make corrections.

In box 308 the system may verify one or more data dependencies in the document by executing the verification functions to determine if the data dependencies have been met. In an embodiment, the system may verify all the data dependencies in the document. In an embodiment, the system may include or generate a consistency flag associated with one or more of links between data elements. If, when verifying the data dependencies, the system determines that a data dependency has been met, the system may set a value for the associated flag indicating that the dependency has been met. If the system determines the data dependency has not been met, the system may set a value for the associated flag indicating that the dependency has not been met. These flags can subsequently be used to provide an indication to the user as to whether the data in the document is consistent.

In box 310, if a verification function indicates that a data dependency has not been met, then the system may correct the discrepancy. The data may be corrected, for example, via the relationship function associated with the data. As an example, if data element A was changed, and the relationship function between data element A and data element B indicates that data element A should be two times data element B (i.e. A=2*B and conversely, A/2=B), then the system may use the formula to compute data element B and replace the value of data element B with the computed value. In an embodiment, the system uses the most recently changed data to compute and replace linked data. For example, if a user changes a value in a table, the system will use the value changed by the user to compute and correct/replace data that depends on the changed value.

In box 312, the system replaced the corrected data in the document and, in box 314, the system generates a final document that includes the corrected data.

As noted above, the relationship function between the first and second data elements may be any type of function that defines a data dependency between the data elements, such as string functions, sum functions, or other types of functions. In each case, the verification function may run the data through the relationship function to determine if the data dependency between the data elements has been met.

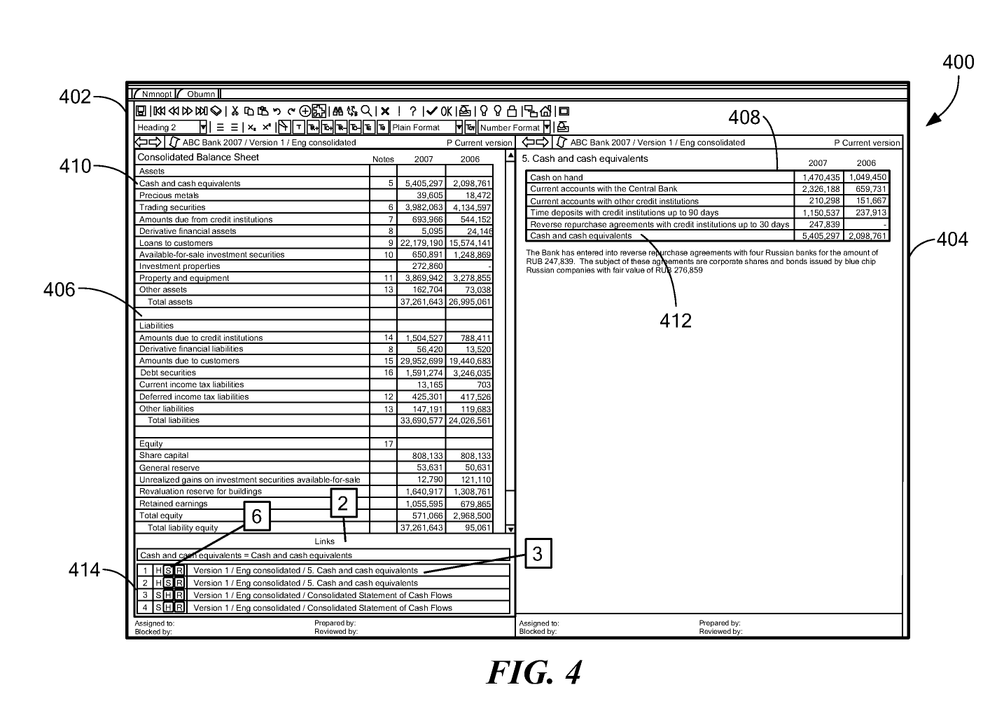

Referring now to FIG. 4, a graphical user interface screen 400 includes features to allow a user to create links between data elements. The screen 400 includes a left panel 402 that can display a portion of the document, and a right panel 404 that can display another (or the same) portion of the document. As shown in FIG. 4, left panel 402 is displaying a table 406 labeled ‘Consolidated Balance Sheet’ and right panel 404 is displaying a table 408 labeled ‘Cash and Cash equivalents.” Both of these tables may appear in the final document.

In this example, the value for line item 410 in the left panel (labeled Cash and Cash Equivalents) should be equal to the line item 412 in the right panel, which is the bottom-line sum for the table 408 in the right panel.

Screen 400 also includes a panel 414 that allows a user to establish links between data elements. Panel 414 includes buttons 416 to create hard links, soft links, or both between selected data elements, such as line item 410 and line item 412.

When a link is created, the system records connected data elements as separate lines in a table of a database. Each element receives a unique ID. The database has fields “hard links” and “soft links”. The field “hard links” of particular element contains all IDs of elements connected through hard links, while the field “soft links” contains all elements connected through soft links.

Accordingly, when user creates a hard link between elements A and B, the system may 1) create IDs for the elements in the database for new data elements added to the database, and 2) add IDs of element B in the field “hard links” of A and vice versa.

Elements connected through a hard link (or a soft link) are set of elements that are related, but that appear in different locations in the document. When the user updates the element, the system may update some or all elements with IDs that are recorded in the database field “hard links” automatically.

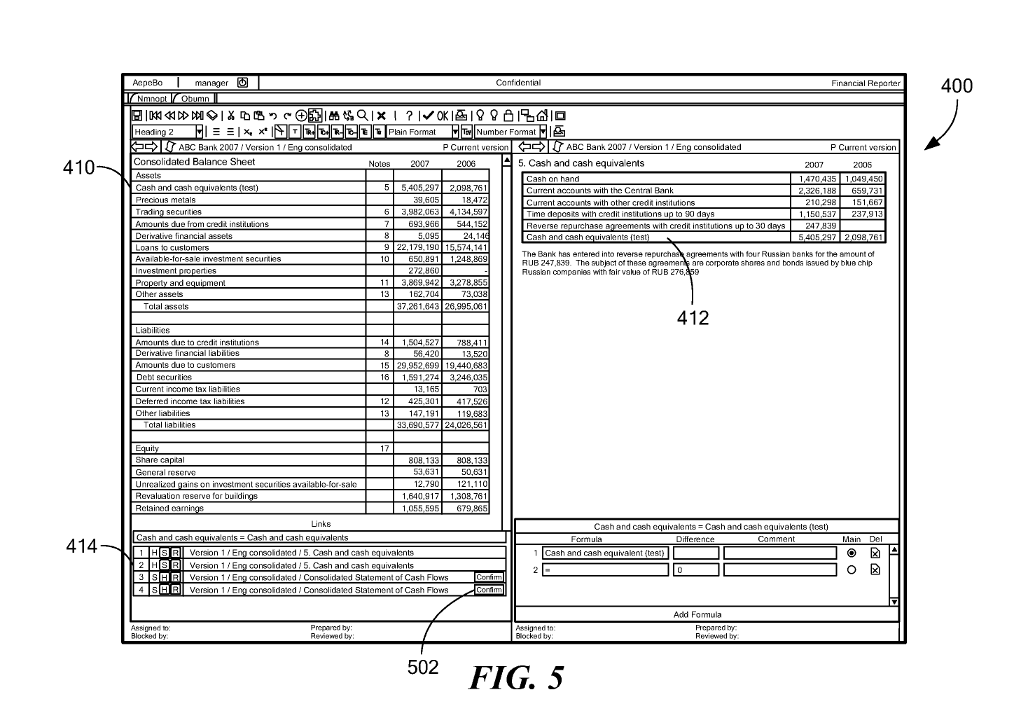

Elements connected through soft link are also related, but appear in different locations in the document. When the value of one element changes, the value of all elements with IDs that are recorded in the database field “soft links” is considered by the system as out of date. Subsequently, the system may prompt the user for verification of out-of-date elements that are connected by a soft link by, for example, asking the user to check and confirm that the values are consistent. Accordingly the system may display a button to allow the user to confirm the consistency of the values (see, e.g., button 502 in FIG. 5).

FIG. 5 shows the graphical user interface screen 400 after a user has made a change to line item 412. As noted above, a link has been established between line item 412 and line item 410. After the change is made, the system verifies whether the data in line item 410 and the data is line item 412 are consistent. In an embodiment, and if the link between the items is a soft link for example, buttons 502 may be generated in panel 414 asking a user to confirm that the data in the two line items is correct. In an embodiment, the buttons or other elements in panel 414 will be displayed in such a way as to alert the user that confirmation is needed. For example, the buttons or other elements may be displayed in red. In an embodiment, the buttons or other elements may be displayed in green if no confirmation is needed or if the user has already confirmed data to be correct.

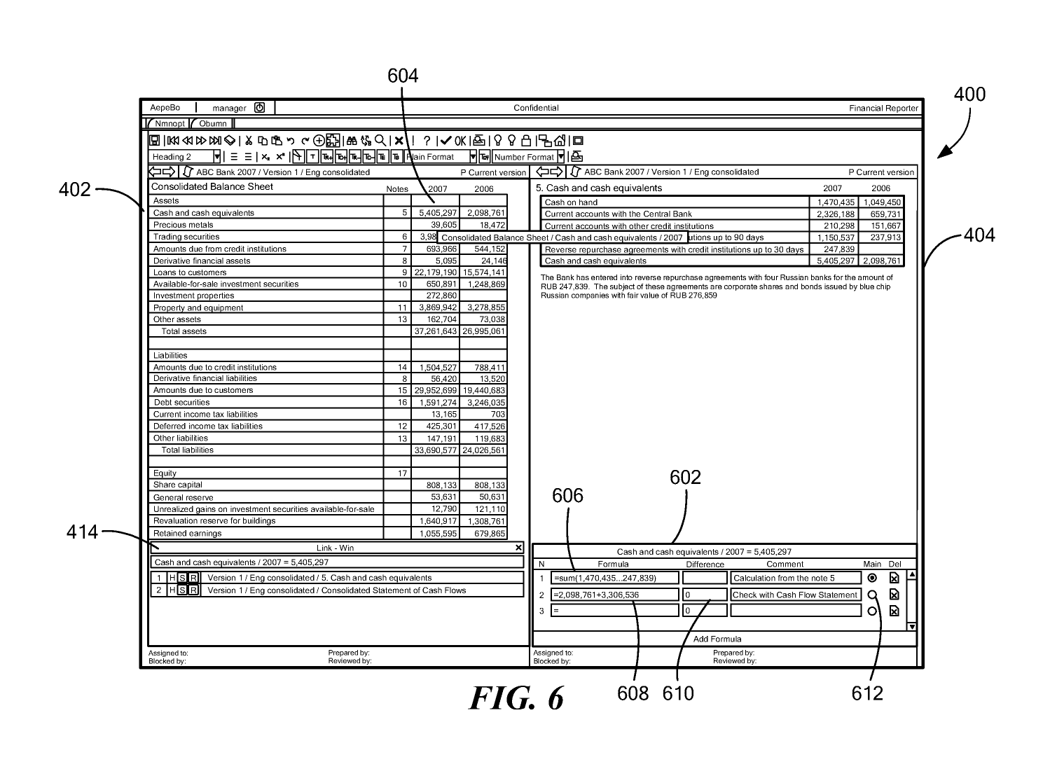

Referring to FIG. 6, graphical user interface screen 400 includes a panel 602 that allows a user to links the cell value from the table ‘Cash and cash equivalents 2007’ 604 to other elements. For example, a user may wish to ensure that the caption “Cash and cash equivalents” in the balance sheet table (left) is equal to one or more of:

total line of the table in box 606 “Cash and cash equivalents”

sum of the preceding lines in the Note 5 “Cash and cash equivalents”

the last line of “Consolidated Statement of Cash Flows” table

“Consolidated Statement of Cash Flows” table: “Cash and cash equivalents YE 2006”+“Net increase in cash and cash equivalents”.

To effectuate these links, a user may link the cell value from the table ‘Cash and cash equivalents 2007’ 604 to other elements using panel 602. The system displays the links in panel 414 and relationship and verification formulas panel 602. The user may also use panels 414 and 602 as navigation tool to cause either panel 402 and/or 404 to display the data related to a link that the user is viewing.

In an embodiment, panel 602 contains a relationship formula or function 606, which calculates the element value, and a verification function or formula 608. Verifying formulas may be not only ‘=’ but ‘>’ and ‘<’ as well. Verifying formulas may also include other tests such as <=, >=, string operations, Boolean comparisons, or any other test or check that can be used to compare data. The user can set up several verifying formulas. Any of these formulas may be reassigned to become a defining and vice versa. In an embodiment, a user can reassign the formulas in this way by using selector 612.

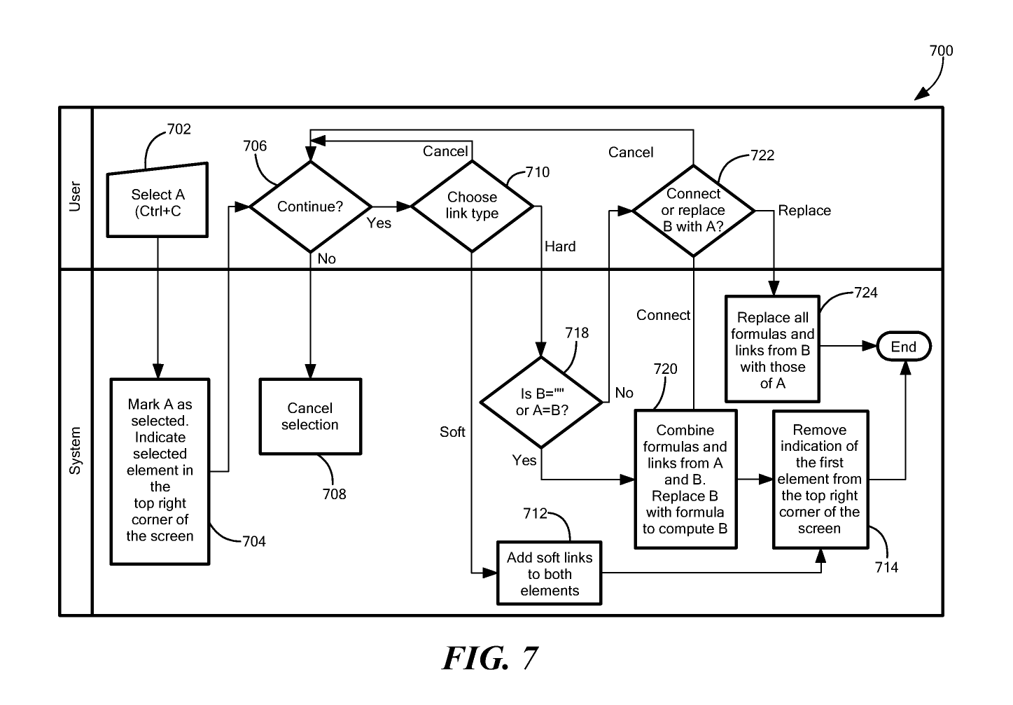

Referring now to FIG. 7, a process 700 for producing a document having consistent data elements includes actions is shown. In box 702 data element A is selected. In box 704, data element A is marked to indicate that it is an active element. In box 706, a determination is made whether to continue. If no, the process proceeds to box 708 to cancel the selection. If yes, the process proceeds to box 710 to choose a link type between element A and another element B (i.e. a hard link or a soft link). If a soft link is chosen, the process proceeds to box 712 and a soft link is added to both elements. The soft link will indicate that, if one of the elements changes, a confirmation is needed by a user to determine if the data remains consistent. From box 712, the process proceeds to box 714 to remove indication of the first element A from the screen (e.g. element A may be de-selected or de-highlighted in the GUI).

If, in box 710, a hard link is chosen, the process proceeds to box 716 where the value of data element B is evaluated. In an embodiment, it is determined whether B=“ ” (i.e. B=a null value) or B=A. If either condition is met, the process proceeds to box 720. In box 720, if any formulas and links already exist with respect to data elements A and/or B, then those formulas and links are combined and the value of B is replaced with a formula that can compute the value of B.

For example, assume A and B are each associated with the following respective relationship formulas: A=M+N and B=X+Y. If A and B are linked with a hard link and given the relationship A=B, these formulas may be combined so that, for example, A is associated with both formulas:

A=M+N 1.

and

A=X+Y 2.

B may also be associated with both formulas. A and B may also be associated with the third formula A=B, which was defined when A and B were linked. Soft links may be combined in similar way.

If neither condition has been met in box 718, the process proceeds to box 722 where it is determined whether to connect A and B or to replace data element B with data element A. In an embodiment, if the data is replaced rather than combined, then only one of the formulas may survive. For example, in the example above, if B is replaced with A, then only one formula (A=M+N) will survive and will be associated with both A and B. In another embodiment, the element B may be completely replaced by an exact copy of A so that no links or formulas originally associated with B would remain.

If it is determined that element A and element B are to be connected, the process proceeds to box 720 as described above. If it is determined that element B is to be replaced by element A, the process proceeds to box 724 where all formulas and links that may already be associated with B are replaced with the formulas and links associated with A. In this case, all the links and formulas previously associated with B are replaced by the links and formulas associated with A so that they are effectively identical elements in the document. This can prevent numbers which are the same from being dependent upon different formulas and dependencies from other areas of the document.

In an embodiment, some or all of the steps described in FIG. 7 may be executed by a processor executing software, by a user, or both. As the process runs, data within document 108 are transformed so that data elements contain or are associated with links, verification functions, relationship functions, etc., and so that data in the document is internally consistent.

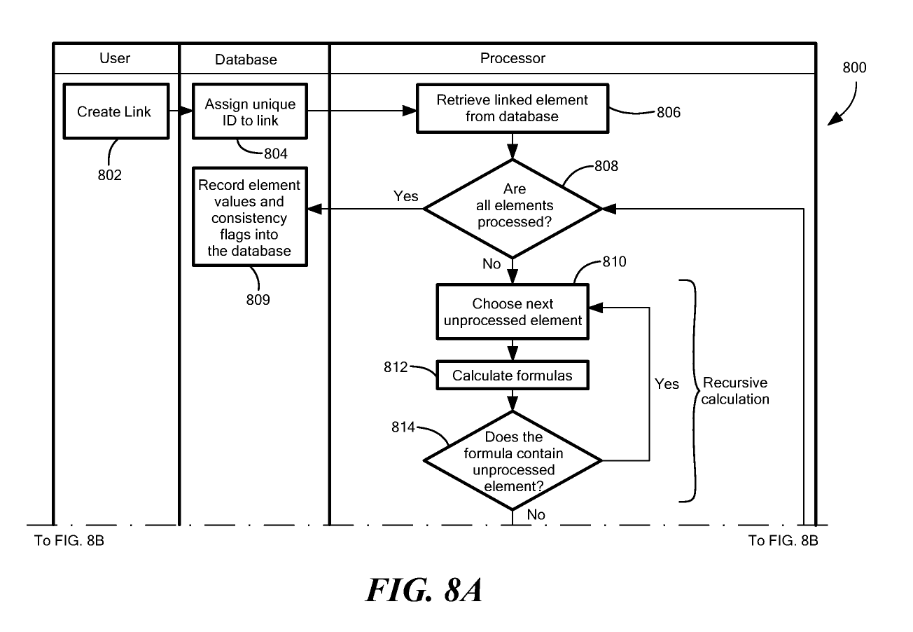

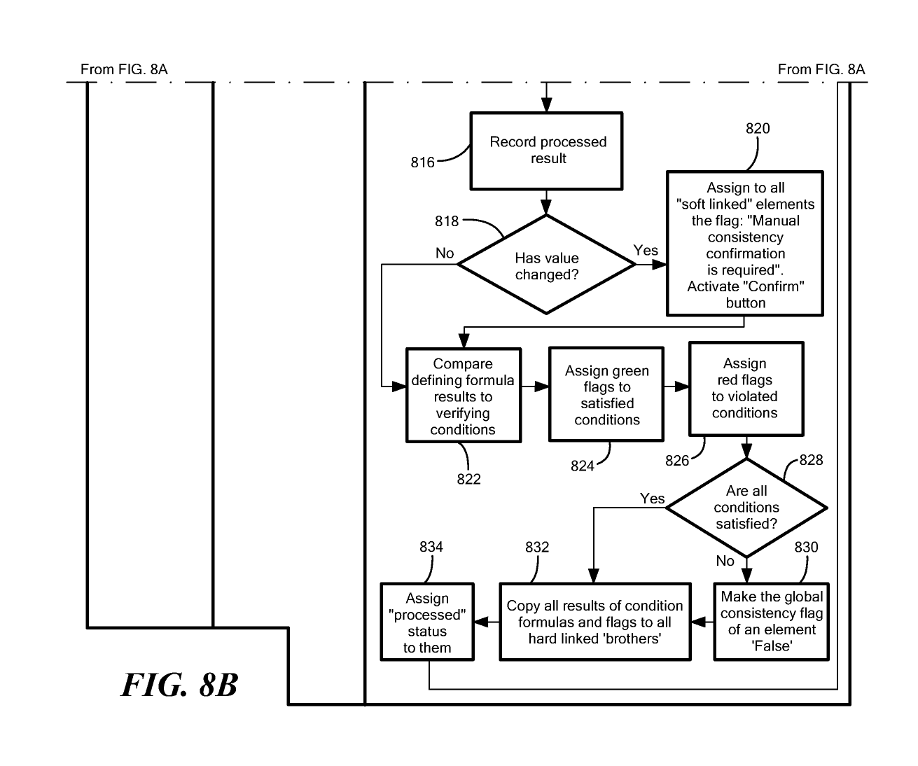

Referring to FIGS. 8A and 8B, a process 800 for processing linked elements is shown. In box 802, a link is created between data elements as described above. In box 804, a unique identifier is assigned to the link. In box 806, the system retrieves the linked data elements from a data store, such as a database or other storage mechanism. In box 808, it is determined whether all the linked data elements have been processed. If yes, the process proceeds to box 809 where the processed element values, flags, and formulas are stored in the data store. If no, the process proceeds to box 810 where the next unprocessed element is selected.

In box 812, formulas (e.g. relationship formulas) associated with the unprocessed element are calculated. In box 814 it is determined whether the formula contains another unprocessed element. If so, the process chooses that element, returns to box 810, and processes the element. This can be performed in a recursive manner until all linked elements have been processed.

In box 814, if the formula does not contain an unprocessed element (i.e. all elements have already been calculated), the process proceeds to box 816 where the result is recorded in the data store.

In box 818, it is determined whether the value of the processed element has changed. If yes, the process proceeds to box 820 where a flag requiring user confirmation is assigned to any soft link. If no, the process proceeds to box 822 where the processed results of a relationship formula are satisfied. In box 824, a GUI indicator (such as a green flag) is assigned and displayed for elements where the value has been satisfied. In box 826 a GUI indicator (such as a red flag) is assigned and displayed for elements where the value has not yet been satisfied.

In box 828, if not all verifying formulas of data element are satisfied, the process proceeds to box 830 and assigns a global consistency flag value “false” to indicate that not all verifying formulas of the element have been satisfied. In box 828, if all verifying formulas of the data element have been satisfied, the process proceeds to box 832 where the computed results for the data elements are copied to the data elements connected to the current one through hard links, and box 834 where the current data element is assigned with ‘processed’ status to it has been processed.

The process 800 may then be applied to the next data element in the document.

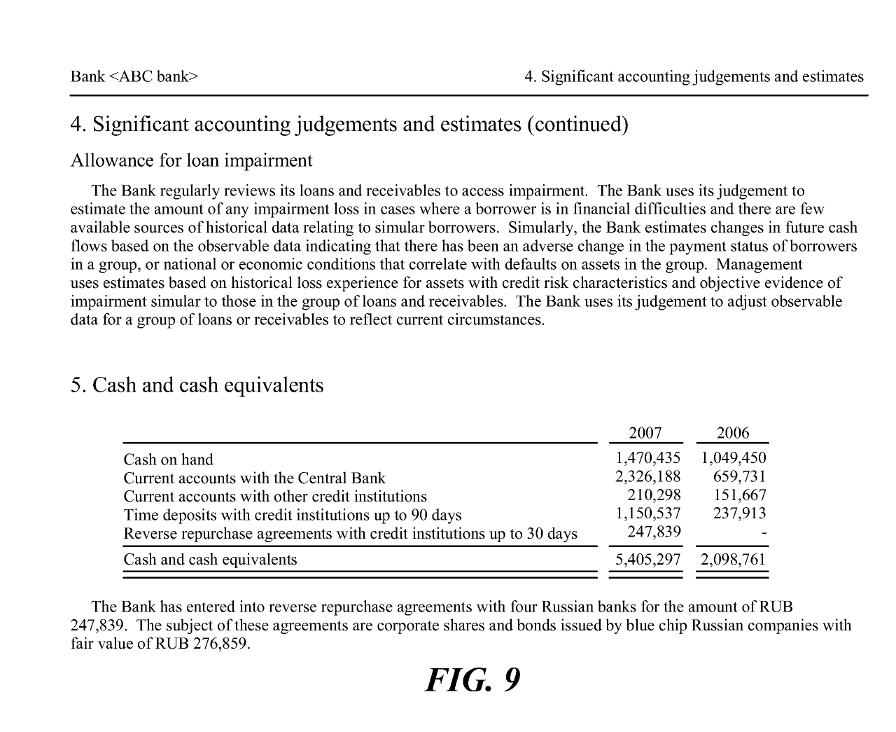

In an embodiment, steps 808, 810, 812, 814, 822, 824, 826, 828, 830, 834 apply to numerical values. If the data elements is a text data elements, the process may change/verify the value in blocks 806-816, then proceed to blocks 818 and 820. Once the data elements have been processed, the system produces a printable document having internally consistent financial data. FIG. 9 shows an example of a portion of a document produced by such a system.

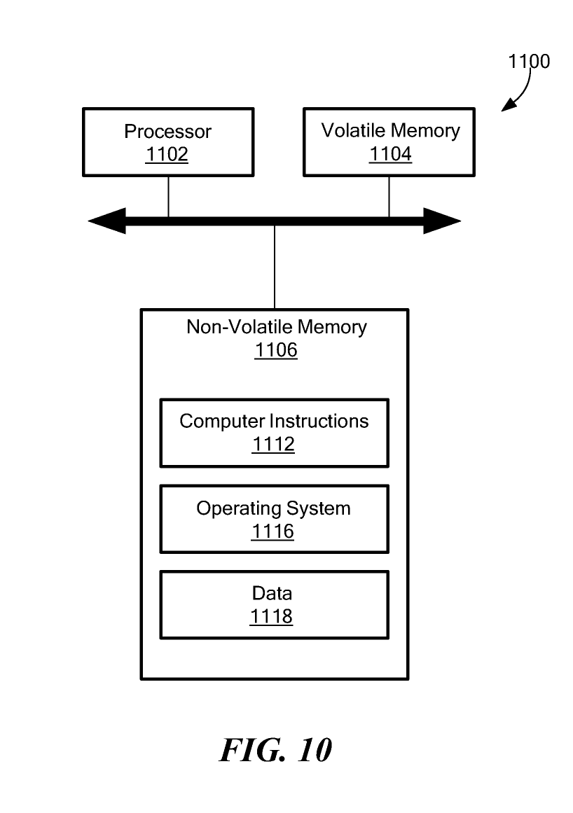

Referring to FIG. 10, an example of computing device 1100 for processing data elements is shown. The computing device 1100 includes a processor 1102, a volatile memory 1104 and a non-volatile 1106. The non-volatile memory 1106 stores computer instructions 1112, an operating system 1116 and data 1118. In one example, the computer instructions 1112 are executed by the processor 1102 out of memory 1104 to perform all or part of the processes described above.

The processes described herein are not limited to use with the hardware and software of FIG. 10; they may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each includes a processor, a non-transitory machine-readable medium or other article of manufacture that is readable by the processor (including volatile and non-volatile memory and/or storage elements), at least one input device, and one or more output devices. Program code may be applied to data entered using an input device to perform any of the processes described herein and to generate output information.

The system may be implemented, at least in part, via a computer program product, (e.g., in a non-transitory machine-readable storage medium), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, volatile memory, magnetic diskette and so forth but does not include a transitory signal per se.

Having described preferred embodiments, which serve to illustrate various concepts, structures and techniques, which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims. All references cited herein are hereby incorporated herein by reference in their entirety.

What is claimed is:

1. A method for generating a document, the method comprising:
creating, by a computing device, link between a first data element in a document and a second data element in a document;
creating, by the computing device, a relationship function between the first data element and the second data element to define a data dependency between the first and second data elements;
associating, by the computing device, one or more verification functions with the link to verify that the data dependency has been met;
verifying, via the verification functions, that each data dependency in the document is met;
correcting, by the computing device, one or more data dependencies that have not been met by computing corrected data via the relationship function;
replacing either the first or second data element with the corrected data; and
generating a final document that includes the corrected data.

2. The method of claim 1 further comprising indicating, via a user interface, any data dependencies that have not been met.

3. The method of claim 2 further comprising allowing, via the user interface, a user to correct one or more data dependencies that have not been met.

4. The method of claim 1 wherein the relationship function comprises a hard data dependency, a soft data dependency, or both.

5. The method of claim 1 wherein correcting the one or more data dependencies includes obtaining, from a user, verification of the correct data.

6. The method of claim 1 wherein the relationship function is a formula that defines a mathematical relationship between the first data element and the second data element.

7. The method of claim 1 wherein the relationship function is a flag indicating the existence of a relationship between the first data element and the second data element.

8. The method of claim 1 further comprising creating a plurality of relationship functions between the first data element and the second data element.

9. The method of claim 1 wherein, if the relationship function comprises a mathematical formula, at least one of the verification functions is a function that calculates the result of the formula.

10. The method of claim 1 wherein, if the relationship function is a flag indicating the existence of a relationship, at least one of the verification functions is a function that queries a user as to whether the dependency has been met.

11. The method of claim 1 wherein generating the final document includes populating one or more tables in the document with the corrected data.

12. The method of claim 1 wherein the data comprises text elements, numerical elements, or both.

13. The method of claim 1 further comprising providing a user interface that allows a user to define the relationship function between the first data element and the second data element.

14. The method of claim 1 wherein the final document is a financial report containing data dependencies between elements in the report.

15. A system for generating a document, the system comprising a computing device configured to:
create a link between a first data element in a document and a second data element in a document;
create a relationship function between the first data element and the second data element to define a data dependency between the first and second data elements;
associate one or more verification functions with the link to verify that the data dependency has been met;
verify, via the verification functions, that each data dependency in the document is met;
correct one or more data dependencies that have not been met by computing corrected data via the relationship function;
replace either the first or second data element with the corrected data; and
generate a final document that includes the corrected data.

16. The system of claim 15 wherein the relationship function comprises a hard data dependency, a soft data dependency, or both.

17. The system of claim 15 wherein correcting the one or more data dependencies includes obtaining, from a user, verification of the correct data.

18. The system of claim 15 wherein the relationship function is a formula that defines a mathematical relationship between the first data element and the second data element.

19. The system of claim 15 wherein the relationship function is a flag indicating the existence of a relationship between the first data element and the second data element.
